(19) United States
(12) Patent Application Publication
(10) Pub. No.: US 2009/0233138 A1
(43) Pub. Date: Sep. 17, 2009

(54) Membrane Electrode and Current Collecting Board Assembly of Electrochemical Cell, and Electrochemical Cell Module

(76) Inventor: Zhijun Gu, Shangahi (CN)

Correspondence Address: WOODS, ROGERS, P.L.C., 1505 LONDON ROAD, CHARLOTTESVILLE, VA, 22902-8681, US

(21) Appl. No.: 12/400,961

(22) Filed: Mar. 10, 2009

(30) Foreign Application Priority Data
Mar. 11, 2008 (CN) 200810034448X

(51) Int. Cl. H01M 8/10

(52) U.S. Cl. 429/30

(57) ABSTRACT

The invention discloses an assembly of a membrane electrode and a current collecting board used for an electrochemical cell, the assembly comprising a membrane layer, a gas diffusion layer on the one side and a layer of porous current collecting board on the one side which are stacked in sequence and wherein the gas diffusion layer on the one side is located between the porous current collecting board on the one side and the membrane. The area surrounding the periphery of the gas diffusion layer on the one side is filled with sealing material which is cured subsequently. The invention further discloses an electrochemical cell module comprising at least one electrochemical single cell which includes an end plate with gas channels, an assembly therefor, and an end plate with gas channels on the other side which are stacked in sequence. When compared with the prior art, this assembly provides a simpler structure and assembly process, thereby decreasing production cost when used on a large scale. Meanwhile, it also improves the effective available area of the membrane electrode. This assembly is also suitable for use in the production of fuel cells, electrolytic cells, regenerative fuel cells and electrochemical oxygen generators.

### TECHNICAL FIELD

The invention relates to an electrochemical cell, and in particular, relates to a membrane electrode and current collecting board assembly of an electrochemical cell, as well as an electrochemical cell module.

### TECHNICAL BACKGROUND

Chinese patent application 99808103.5 discloses a hermetic sealing assembly comprised of a bipolar plate and membrane electrode unit of a polymeric electrolyte membrane fuel. The bipolar plate and membrane electrode unit can be bonded by curable polymer. The hermetic sealing assembly is produced by coating adhesive beads on the gas conduits outside and inside the gas chamber. According to the present invention, these assemblies can be laminated and bonded together to form polymeric electrolyte fuel cell stack.

The above technical solution makes some improvement compared with the prior art. However, the bipolar plate not only acts to lead out voltage current, but also is used for constructing the sealed gas chamber, so the material of the bipolar plate should have both good conductivity and good resistance to air leakage. Meanwhile, an internal gas conduit is necessary in the bipolar plate's structure, which will result in some complexity as well as a decrease in the effective area available for the membrane electrode. In addition, in order to improve the cell's performance, it is always necessary to dispose the flow field on the bipolar plate, which requires the bipolar plate to be highly processable, thereby raising the requirements to the bipolar plate are further enhanced.

Chinese patent application 200610029938.1 discloses a sealing structure of an embedded compact power-generating cell. The compact power-generating cell includes a hydrogen side end plate, two pieces of metal conductive titanium webs, two diffusion layers, a proton exchange membrane electrode, an oxygen side end plate, a red and black socket, and four stainless steel screws with four nuts. One of the end plates of the compact power-generating cell is groove-like, and the other is boss-like. The titanium metal web is twisted on the end plates beforehand by means of a conductive socket which includes a red and a black socket disposed on the front side and back side of the end plate, respectively.

When compared with the prior art, the technical solution described above makes some progress. However, the structure and assembly process thereof are relatively complicated, and suffer from a high manufacturing cost.

### SUMMARY OF THE INVENTION

For the purpose of overcoming the drawbacks described in the Chinese patent application 99808103.5 including high requirements for the bipolar plate and low effective area availability for the membrane electrode, as well as the drawbacks described in Chinese patent application 200610029938.1 relatively complicated structure and assembly process and high manufacturing cost, the present invention provides a membrane electrode and current collecting board assembly for an electrochemical cell and an electrochemical cell module.

The invention solves the afore-mentioned technical problems as follows:

An assembly for a membrane electrode and current collecting board is provided, which comprises a membrane layer, at least one gas diffusion layer on the one side and a layer of porous current collecting board on the one side, which are stacked in sequence, wherein the membrane includes a reactive area and a non-reactive area. The porous current collecting board on the one side comprises a reactive area, a non-reactive area and an electric leading-out area. The at least one gas diffusion layer on the one side is located between the porous current collecting board on one the side and the membrane. Its area corresponds to the reactive areas of the porous current collecting board and the membrane. The area surrounding the periphery of the at least one gas diffusion layer on the one side which corresponds to the non-reactive areas of the porous current collecting board and the membrane is filled with sealing material which is cured subsequently.

An alternative solution is to provide at least one gas diffusion layer on the other side which is attached to the side face of the membrane opposite to where the gas diffusion layer on the one side is disposed. In addition, a layer of porous current collecting board is provided on the other side which is attached to the gas diffusion layer on the other side. The porous current collecting board on the other side comprises a reactive area, a non-reactive area and an electric leading-out area. The area of the at least one gas diffusion layer on the other side corresponds to the reactive areas of the porous current collecting board on the other side and the membrane. The area surrounding the periphery of the at least one gas diffusion layer on the other side which corresponds to the non-reactive areas of the porous current collecting board on the other side and the membrane is filled with sealing material which is subsequently cured.

Another alternative solution is to provide a layer of porous current collecting board on the other side which is attached to the side face of the membrane opposite where the gas diffusion layer on the one side is disposed. The attached part of the non-reactive areas of the porous current collecting board on the other side and the membrane is filled with and adhered by sealing material which is cured subsequently.

Yet a further alternative solution is to provide at least one gas diffusion layer on the other side which is attached to the side face of the membrane opposite where the gas diffusion layer on the one side is disposed while a layer of porous current collecting board is disposed on the other side which is attached to the gas diffusion layer on the other side. The area of the at least one gas diffusion layer on the other side corresponds to the area of the membrane.

The cured seal material has a width of 0.05-2 mm. The sealing material may be thermoplastic plastic, thermoset plastic, or elastic polymer, although silicon rubber is preferred.

The membrane layer can be a proton exchange membrane, and there can be catalyst layers disposed at least in the reactive area on both sides of the membrane layer.

Each gas diffusion layer can be made of at least one conductive gas-permeable material selected from the group consisting of carbon fiber paper, carbon fiber cloth, gas-permeable graphite plate and metal web. The side adjacent to the membrane of each gas diffusion layer can be coated with a catalyst layer.

Each porous current collecting board is porous and gas-permeable in the reactive area, but is substantially gas-tight in the non-reactive area. Furthermore, each porous current collecting board is made of corrosion resistant and conductive metal material.

An electrochemical cell module is provided which includes at least one electrochemical single cell. The electrochemical single cell includes an end plate with gas channels on one side, an assembly having a membrane electrode and a current collecting plate, and an end plate with gas channels on the other side. The three components described above are stacked in sequence.

The end plate with gas channels can be made of at least one material selected from thermoplastic polymer, thermoset polymer and elastic polymer. The polymer material is preferably inject-moldable plastic material.

The electrochemical cell can be a fuel cell, an electrolytic cell, a regenerative fuel cell, or an electrochemical oxygen generator.

The electrochemical cell module further comprises a printed circuit board (PCB), which is directly welded onto the electric leading-out area of each porous current collecting board.

The PCB may include a circuit used for controlling the electrochemical cell, or light-emitting element.

The positive advancement of the present invention is that, when compared with the prior art, it distributes the requirements for conductivity, impermeability and processability to different materials so that the traditional costly carbon or metal material can be replaced by plastic material, and the structure and assembly process are also simplified. As a result, commercial production costs can be decreased. At the same time, the effective area availability of the membrane electrode is enhanced. The present solution is suitable for the production of a fuel cell, an electrolytic cell, a regenerative fuel cell, and an electrochemical oxygen generator.

### DESCRIPTION OF THE DRAWINGS

FIG. 1 to FIG. 4 are schematic views showing the first example of an assembly according to the invention.

FIG. 5 is a schematic view showing the second example of an assembly according to the invention.

FIG. 6 is a schematic view showing the third example of an assembly according to the invention.

FIG. 7 is a schematic view showing the fourth example of an assembly according to the invention.

FIG. 8 is a schematic view showing the first example of a cell module according to the invention.

FIG. 9 is a schematic view showing the second example of a cell module according to the invention.

### DETAILED DESCRIPTION OF THE INVENTION

1. Examples of the Assembly

### EXAMPLE 1

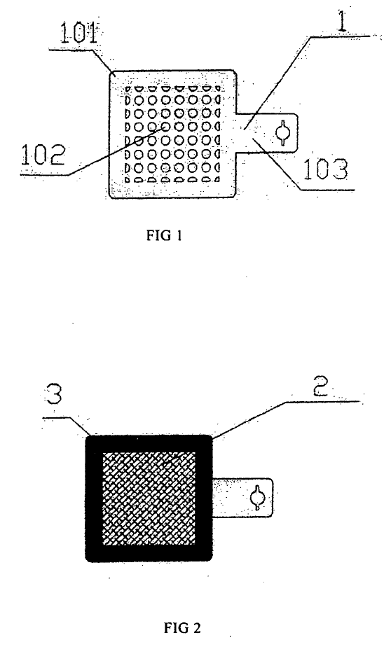

A metal plate 1 used for the porous current collecting plate on the one side is shown in FIG. 1. The middle area of the metal plate, which is reactive area 101, is full of fine through-holes, and the periphery without holes is non-reactive area 102. The stem-like protrusion on the right side is electric leading-out area 103. The end of the electric leading-out area has a through-hole used for electrical connection.

FIG. 2 shows an intermediate product provided with carbon paper 2 used as a gas diffusion layer on the one side and glue 3 used as sealing material. The area of carbon paper 2 substantially corresponds to the reactive area 101 of metal plate 1. The location of glue 3 substantially corresponds to non-reactive area 102 of metal plate 1.

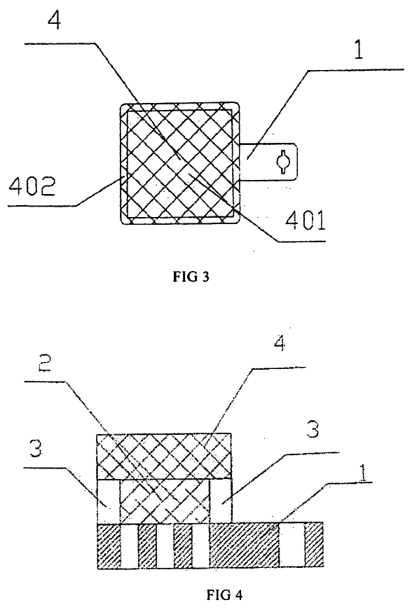

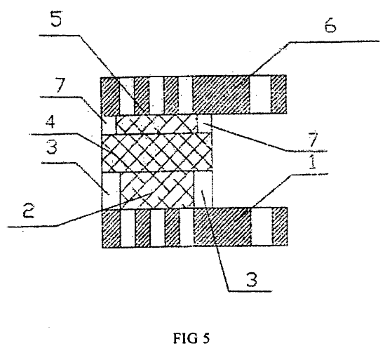

FIG. 3 shows the assembly provided with membrane 4. The center section of membrane 4 is reactive area 401, and the periphery is non-reactive area 402.

The area shown in the figure is filled with glue 3, which produces good sealing after being cured. The glue 3 has a width of 1.5 mm after being cured. After pressing and assembling, the excess glue 3 will expanded outward, and the excess sections can be cut off. The glue 3 is silicon rubber.

Membrane 4 is proton exchange membrane with both sides coated with catalyst. The full name of carbon paper 2 is carbon fiber paper.

The surface of metal plate 1 is plated with gold, thus possessing good corrosion resistance.

### EXAMPLE 2

FIG. 5 is a modification of the assembly shown in Example 1 which is further provided with carbon paper 5 used as a gas diffusion layer on the other side. Metal plate 6 is used as a porous current collecting plate on the other side, and glue 7 is used as sealing material.

The locational relationship of carbon paper 5, metal plate 6 and glue 7, as well as the distribution of the reactive area, the non-reactive area and the electric leading-out area is similar to that of metal plate 1, membrane 4 and carbon paper 2 in example 1. The figures are already enough for clear comprehension, so it's not necessary to mark each part with indicative numbers.

### EXAMPLE 3

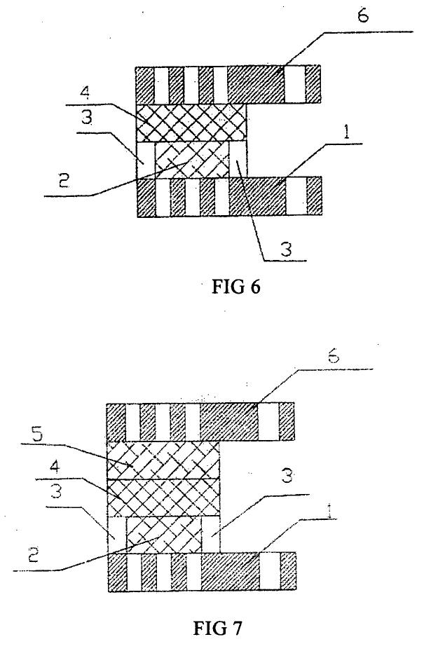

FIG. 6 is a modification of the assembly shown in Example 1, which is further provided with metal plate 6 used as porous current collecting board on the other side and glue 7 used as seal material. Since the assembly is used to prepare an electrolytic cell module, the electrolytic cell has an extremely high polarized overvoltage during operation. No carbon paper 5 is used in order to avoid electric erosion, so the glue 7 is nearly too thin to be visible in the figures. The locational relationship of the other elements is similar to that of example 2.

2. Examples of Module

### EXAMPLE 1

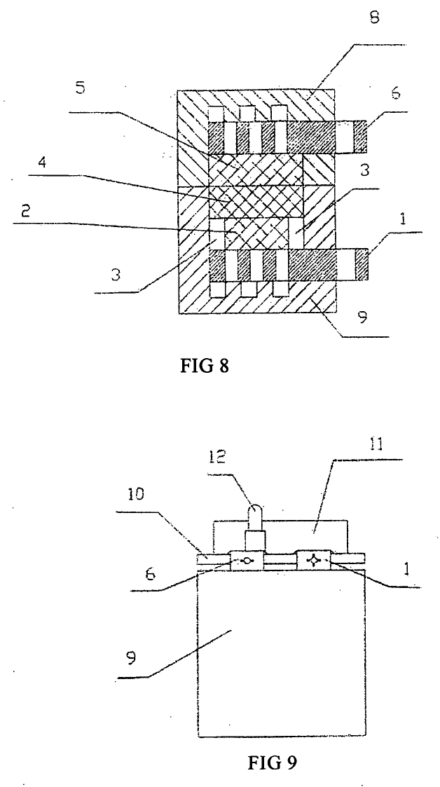

FIG. 8 shows a fuel cell module which is constructed by providing the assembly of the above examples with an end plate 8 on one side, an end plate 9 on the other side to form a single cell. A plurality of single cells are stacked together. Both the end plate 8 on the one side and the end plate 9 on the other side comprise PC material, i.e., polycarbonate.

### EXAMPLE 2

FIG. 9 shows a fuel cell module including PCB 10, which is directly welded to the electric leading-out area 103 of metal plate of each single cell. An element 11 is used for the fuel cell control circuit, while light-emitting diode 12 is mounted on the PCB 10.

What is claimed is:

1-15. (canceled)

16. An assembly for an electrochemical cell comprising:
a first corrosion resistant metal plate with a middle reactive area having a plurality of perforations formed thereacross and therethrough, a peripheral non-reactive area and a stem-like protrusion extending away therefrom with a single perforation formed through one end thereof;
a first gas diffusion layer placed on top of the middle area of said plate, said gas diffusion layer corresponding in size and configuration to the size and configuration of the middle area of said metal plate;
a first sealing glue layer corresponding in size and configuration to the size and configuration of the peripheral area of said metal plate, said glue layer being applied onto the peripheral area of said metal plate; and
a two-sided proton exchange membrane both sides of which are coated with a catalyst, said membrane having a middle reactive area on both sides of said membrane corresponding in size and configuration to the size and configuration of the middle area of said plate and having further a peripheral non-reactive area corresponding in size and configuration to the size and configuration of the peripheral area of said plate, wherein the peripheral non-reactive area of one side of said membrane is placed on top of said first gas diffusion layer and sealed in place by said sealing glue layer.

17. The assembly of claim 16 wherein said first gas diffusion layer is selected from the group consisting of carbon fiber paper, carbon fiber cloth, gas-permeable graphite plate and metal web.

18. The assembly of claim 16 wherein said metal plate is plated with gold.

19. The assembly of claim 16 wherein said first sealing glue layer is between 0.05 mm and 2 mm wide and said first sealing glue layer is one selected from the group consisting of thermoplastic plastic, thermoset plastic, elastic polymer or silicon rubber.

20. The assembly of claim 16 wherein said metal plate is porous and gas-permeable in the middle reactive area and gas-tight and impermeable in the peripheral non-reactive area.

21. The assembly of claim 16 further comprising:
a second gas diffusion layer placed on top said of the other side of said membrane, said second gas diffusion layer corresponding in size and configuration to the size and configuration of the middle area of said metal plate;
a second sealing glue layer corresponding in size and configuration to the size and configuration of the peripheral area of said first metal plate, said glue layer being applied onto the peripheral area of the other side of said membrane; and
a second corrosion resistant metal plate with a middle reactive area having a plurality of perforations formed thereacross and therethrough, a peripheral non-reactive area and a stem-like protrusion extending away therefrom with a single perforation formed through one end thereof, the middle reactive area and the peripheral non-reactive area corresponding in size and configuration to the size and configuration of the middle reactive area and the peripheral area of said first metal plate, wherein the peripheral non-reactive area of said second metal plate is placed on top of said second gas diffusion layer and sealed in place by said second sealing glue layer.

22. The assembly of claim 21 wherein each said metal plate is plated with gold.

23. The assembly of claim 21 wherein said each sealing glue layer is between 0.05 mm and 2 mm wide and each said sealing glue layer is one selected from the group consisting of thermoplastic plastic, thermoset plastic, elastic polymer or silicon rubber.

24. The assembly of claim 21 wherein each said metal plate is porous and gas-permeable in the middle reactive area and gas-tight and impermeable in the peripheral non-reactive area.

25. The assembly of claim 16 further comprising:
a second thin sealing glue layer corresponding in size and configuration to the size and configuration of the peripheral area of said first metal plate, said glue layer being applied onto the peripheral area of the other side of said membrane; and
a second corrosion resistant metal plate with a middle reactive area having a plurality of perforations formed thereacross and therethrough, a peripheral non-reactive area and a stem-like protrusion extending away therefrom with a single perforation formed through one end thereof, the middle reactive area and the peripheral non-reactive area corresponding in size and configuration to the size and configuration of the middle reactive area and the peripheral area of said first metal plate, wherein the peripheral non-reactive area of said second metal plate is placed on top of the other side of said membrane and sealed in place by said second sealing glue layer.

26. The assembly of claim 25 wherein each said metal plate is plated with gold.

27. The assembly of claim 25 wherein each said sealing glue layer is between 0.05 mm and 2 mm wide and said first sealing glue layer is one selected from the group consisting of thermoplastic plastic, thermoset plastic, elastic polymer or silicon rubber.

28. The assembly of claim 26 wherein each said metal plate is porous and gas-permeable in the middle reactive area and gas-tight and impermeable in the peripheral non-reactive area.

29. The assembly of claim 16 further comprising:
a second thin sealing glue layer corresponding in size and configuration to the size and configuration of the peripheral area of said first metal plate, said glue layer being applied onto the peripheral area of the other side of said membrane;
a two-sided second gas diffusion layer corresponding in size and configuration to said first gas diffusion layer placed on top of and held in place by said second sealing glue layer;
a third thin sealing glue layer corresponding in size and configuration to the size and configuration of the peripheral area of said first metal plate, said glue layer being applied onto one side of said second gas diffusion layer in a space corresponding to the peripheral area of the other side of said membrane; and
a second corrosion resistant metal plate with a middle reactive area having a plurality of perforations formed thereacross and therethrough, a peripheral non-reactive area and a stem-like protrusion extending away therefrom with a single perforation formed through one end thereof, said second metal plate being placed on top of and held in place by said third sealing glue layer.

30. The assembly of claim 29 wherein each said metal plate is plated with gold.

31. The assembly of claim 29 wherein each said sealing glue layer is between 0.05 mm and 2 mm wide and said first sealing glue layer is one selected from the group consisting of thermoplastic plastic, thermoset plastic, elastic polymer or silicon rubber.

32. The assembly of claim 29 wherein each said metal plate is porous and gas-permeable in the middle reactive area and gas-tight and impermeable in the peripheral non-reactive area.

33. The assembly of claim 29 further comprising:
a first end plate having a plurality of gas channels formed therein, said end plate placed on the other side of said first corrosion resistant metal plate which end plate extends around and encompasses the edges of said first corrosion resistant metal plate, said first and said second glue layers and said membrane, wherein an opening is through which the stem-like protrusion of said first corrosion resistant metal plate extends; and
a second end plate having a plurality of gas channels formed therein, said end plate placed on the other side of said second corrosion resistant metal plate which end plate extends around and encompasses the edges of said second corrosion resistant metal plate, said third glue layer and said second gas diffusion layer, wherein an opening is through which the stem-like protrusion of said second corrosion resistant metal plate extends.

34. The assembly of claim 33 wherein said first and said second end plate are both made from polycarbonate.

35. The assembly of claim 33 further comprising a printed circuit board welded on to the stem-like protrusion of said first metal plate.
